(19) United States
(12) Patent Application Publication
(10) Pub. No.: US 2015/0185852 A1
(43) Pub. Date: Jul. 2, 2015

(54) RING MOBILE DEVICE AND OPERATION METHOD OF THE SAME

(71) Applicant: DAU-NING GUO, New Taipei City (TW)

(72) Inventor: DAU-NING GUO, New Taipei City (TW)

(21) Appl. No.: 14/143,084

(22) Filed: Dec. 30, 2013

(51) Int. Cl. G06F 3/01

(52) U.S. Cl. CPC G06F 3/017

(57) ABSTRACT

Disclosed are a ring mobile device and an operation method thereof. The ring mobile device includes an action ring for being worn on a finger, a device body for being worn on a wrist, and connection line configured to connect the action ring and the device body. The action ring includes a finger action sensor for sensing an action of the finger so as to generate finger action data. The device body includes a support body and a control unit having a storage unit, an output unit, a power unit, a wrist action sensor configured to sense an action of the wrist and generates wrist action data, a processing unit configured to generate integrated action data and an integrated action mode based on the finger action data and the wrist action data, and a wireless communication unit configured to transmit the integrated action data and the integrated action mode.

### BACKGROUND OF THE INVENTION

1. Field of the Invention

The present invention generally relates to a ring mobile device and an operation method of the same, and more specifically to a ring mobile device having an action ring on a finger and a device body on a wrist used to generate and transmit integrated action data and an integrated action mode indicative of a hand action, and an operation method of the ring mobile device.

2. The Prior Arts

One of the most important organs of human kind is hands, possessing various functions and providing many complex actions and gestures to finish certain work, like holding and moving an object or tool, or pointing to a specific direction. For the high friendly human-machine interface, it is always a must to provide some appropriate hand sensing device for sensing the delicate actions or gestures of the hands, and then electrical signals, electronic data or information are generated and provided for the electronic devices to perform specific predetermined processes.

For the computer game, the user needs to wear a suitable sensor on the hands to convert the hand actions into control instruction, which is received by the game host device to control the variation of the specific images displayed on the display device, such as opening the gate, turning the steering wheel, changing the weapon, or triggering the gun, throwing some object, fighting, and so on. Therefore, the game is truly in response of the hand action of the user, thereby enhancing the sense of presence and the effect of amusement.

In particular, the surgeons may employ the hand sensing device as an assistant tool to assist the surgeries such that the doctor easily harnesses the micro scalpel of the endoscope to perform the essential operation on the internal organ, like cutting off a polyp or lump in the intestines by moving the laser scalpel, or suturing the deep wound tissue.

Additionally, it is often necessary to use the isolated hood to perform some risky biological or chemical experiments for the sake of safety, such as using the external gloves provided and fixed to the hood to control the organisms, chemicals or instruments isolated in the hood. Some delicate actions are difficult for the hands in such gloves, like holding a test tube and pouring the chemical into a flask with a narrow opening. The hood provided with the mechanical hands is thus needed and the user can employ the hand sensing device synchronously simulating the hand action to instantaneously control each mechanical finger of the mechanical hands.

The hand sensing device of the prior arts usually comprises five sensors configured to be worn on five fingers, respectively. As disclosed in U.S. Pat. No. 8,553,001 titled as “Methods and apparatus for determining local coordinate frames for a human hand”, the method and apparatus primarily uses the sensors provided on the five fingers to simultaneously sense the swaying action of each finger so as to determine the hand action. This patent, however, did not sense the action of the wrist, and only the action modes for operating the keyboard are effectively obtained. Besides, normal actions of the hands are seriously interfered with, like calling, writing or even drinking a cup of tea. Such inconveniences might cause mistakes, resulting in fatal malfunction or functional disability.

Furthermore, another technology in the prior arts is that the tips of five fingers are provided with sensors and another sensor is worn on the back of the hand such that the position and movement direction of the back are detected to increase the correctness of determining the action of the tips. This technology only detects the y-z vectors of the tips and the x-y-z vectors of the back, and thus the vectors of the wrist are still not sensed such that the hand behavior mode obtained only comprises the relative vectors corresponding to the five tips without the true response of the actual action of the hand.

Therefore, it greatly needs a ring mobile device with simpler structure to improve the correctness of determining the hand action so as to generate the hand action data and mode providing for the external processing device to perform the corresponding operations, and an operation method of the ring mobile device is also needed to enhance the stability of operation and increase the reliability and durance in actual applications, thereby solving the issues in the prior arts.

### SUMMARY OF THE INVENTION

The primary objective of the present invention is to provide a ring mobile device comprises an action ring, a device body and connection line configured to connect the action ring and the device body. The action ring and the device body are designed for being worn on a finger and a wrist, respectively. The action ring comprises a ring body and a finger action sensor integrated with the ring body. The ring body is specifically designed for the finger to insert, and the finger action sensor is configured to sense an action of the finger so as to generate corresponding finger action data.

The device body on the wrist may comprise a support body and a control unit. The control unit is configured to be integrated with the support body, and the support body is designed for the wrist to insert. The control unit comprises a processing unit, a wrist action sensor, a storage unit, a wireless communication unit, an output unit and a power unit. The power unit provides electricity, and the wrist action sensor, the storage unit, the wireless communication unit and the output unit are connected to the processing unit such that the processing unit manipulates all the whole electrical operations.

The wrist action sensor is configured to sense an action of the wrist and generate wrist action data, which is transmitted to the processing unit. Based on the finger action data and the wrist action data, the processing unit calculates integrated action data and an integrated action mode which are transmitted to the wireless communication unit. At the same time, the processing unit further generates a control signal transmitted to the output unit.

The wireless communication unit employs a wireless means like WiFi or Bluetooth, to transmit the integrated action data and the integrated action mode to an external processing device so as to perform the corresponding operation, such as moving the cursor on the PC or clicking an icon for a specific function.

Additionally, wireless communication unit may receive the control information from the external processing device, like control instructions, parameters, operation modes, which are stored in the storage unit through the processing unit. Thus, the control information stored in the storage unit can be provided for the processing unit to achieve the purpose of controlling the processing unit.

The output unit comprises a state display unit and/or an infrared (IR) transceiver unit. The state display unit is configured to display the related information for the control signal, such as action state or action type. The infrared transceiver unit transmits the IR ray to another external infrared transceiver unit, and also receives the information transmitted by the IR ray from the external infrared transceiver unit.

The above finger action sensor can be replaced by a magnetic object, and the control unit further comprises a magnetic field sensor such that the connection line is omitted. The magnetic field sensor is configured to wireless sense the intensity and variation of the magnetic field generated by the magnetic object so as to generate the corresponding magnetic field data, like position and direction, which is used to form the finger action data provided for the control unit to achieve the purpose of sensing the whole hand action.

Another objective of the present invention is to provide an operation method of the ring mobile device at least comprising an action ring and a device body for being worn on a finger and a wrist, respectively. The action ring and the device body are electrically connected by a connection line. The action ring comprises a finger action sensor and a ring body, and the device body comprises a support body and a control unit, which comprises a processing unit, a wrist action sensor, a storage unit, a wireless communication unit, an output unit and a power unit. The processing unit is configured to manipulate the whole electrical operations.

Specifically, the operation method of the present invention generally comprises a step of first using the processing unit of the device body through a connection line to read finger action data, which is generated by the finger action sensor of the action ring, at the same time, reading wrist action data generated by the wrist action sensor of the deice body, and then analyzing the finger action data and the wrist action data to calculate integrated action data.

Next, the processing unit compares the integrated action data with a plurality of action models stored in a storage unit so as to calculate a corresponding integrated action mode. Further, based on the integrated action data and the integrated action mode, a control signal is generated and transmitted to the output unit, which is configured to display the related information. Finally, the wireless communication unit is used to transmit the integrated action data and the integrated action mode to an external processing unit for performing the corresponding operation.

Therefore, the method of the present invention employs the processing unit to receive the finger action data from the action ring, at the same time, receive the wrist action data from the wrist action sensor, and fetch the action mode stored in the storage unit so as to precisely determine the hand action such that the output unit displays the information related to the hand action like number, text, symbol, icon, light, flash, vibration and sound, used to inform the operator of the current situation. The wireless communication unit may also transmit the integrated action data and the integrated action mode to the external processing unit or the remote/backend device for more precisely determining the hand action or storing the data, thereby implementing the function of remote control.

Moreover, the operation method may further comprise a step of receiving the updated data from the remote/backend device through the wireless communication unit, such as updated parameters and operation modes, and the processing unit stores the updated data in the storage unit for subsequent processes for determining the hand action or further treatments. The purpose of updating or changing the operation of the ring mobile device is thus achieved by the wireless means.

The finger action sensor is replaced by the magnetic object such that the method of the present invention employs the magnetic field sensor to sense the intensity, position and direction of the magnetic field generated by the magnetic object. At the same time, the processing unit receives the information generated by the magnetic field sensor to determine the finger action, thereby implementing the sensing function of the finger action. For instance, the magnetic object is made of ferromagnetic material like magnet particles, and the magnetic field sensor is implemented by the Hall element or inductive element. As a result, the total size is greatly shrunk and the weight is much reduced, thereby improving the practicality and convenience for use.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing a ring mobile device according to the first embodiment of the present invention;

FIG. 2 is a functional block diagram of the ring mobile device of the first embodiment;

FIG. 3 is a view showing one illustrative example of the ring mobile device of the first embodiment;

FIG. 4 is a view showing a ring mobile device according to the second embodiment of the present invention;

FIG. 5 is a functional block diagram of the ring mobile device of the second embodiment;

FIG. 6 is a view showing one illustrative example of the ring mobile device of the second embodiment;

FIG. 7 is a flowchart showing an operation method of the ring mobile device according to the third embodiment of the present invention; and

FIG. 8 is a flowchart showing on operation method of the ring mobile device according to the fourth embodiment of the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

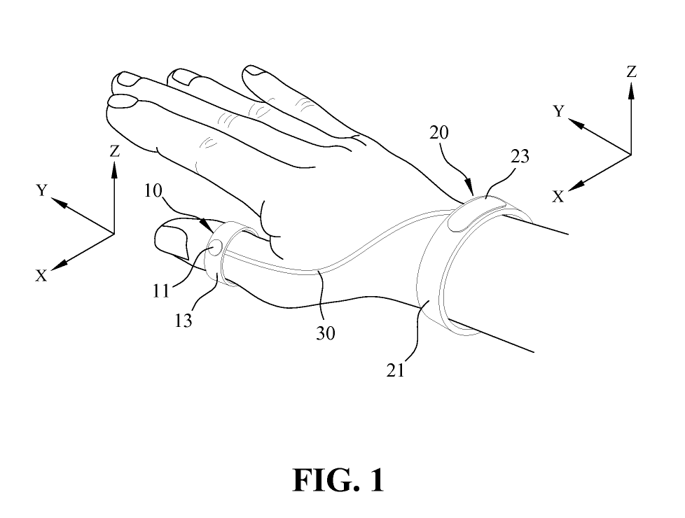

Please refer to FIG. 1 illustrating the ring mobile device according to the first embodiment of the present invention. As shown in FIG. 1, the ring mobile device of the first embodiment generally comprises an action ring 10, a device body 20 and connection line 30 configured to connect the action ring 10 and the device body 20. The action ring 10 is configured to be worn on a finger, and the device body 20 worn on a wrist.

Specifically, the action ring 10 comprises a finger action sensor 11 and a ring body 13. The ring body 13 is a ring object for the finger to insert, and provided/integrated with the ring body 13. The finger action sensor 11 is configured to sense an action of the finger so as to generate corresponding finger action data, comprising the displacement, acceleration and movement of the hand. An accelerator or a gyro is used to implement the finger action sensor 11. In particular, the finger action sensor 11 is preferably a micro electronic mechanical system {MEMS} device with a function of sensing a three-axis displacement, acceleration and angular displacement, like the displacement, acceleration and angular displacement in the x, y and z axes shown in FIG. 1. The ring body 13 is made of plastic, rubber metal or alloy material, and designed for being worn on any finger, like a thumb.

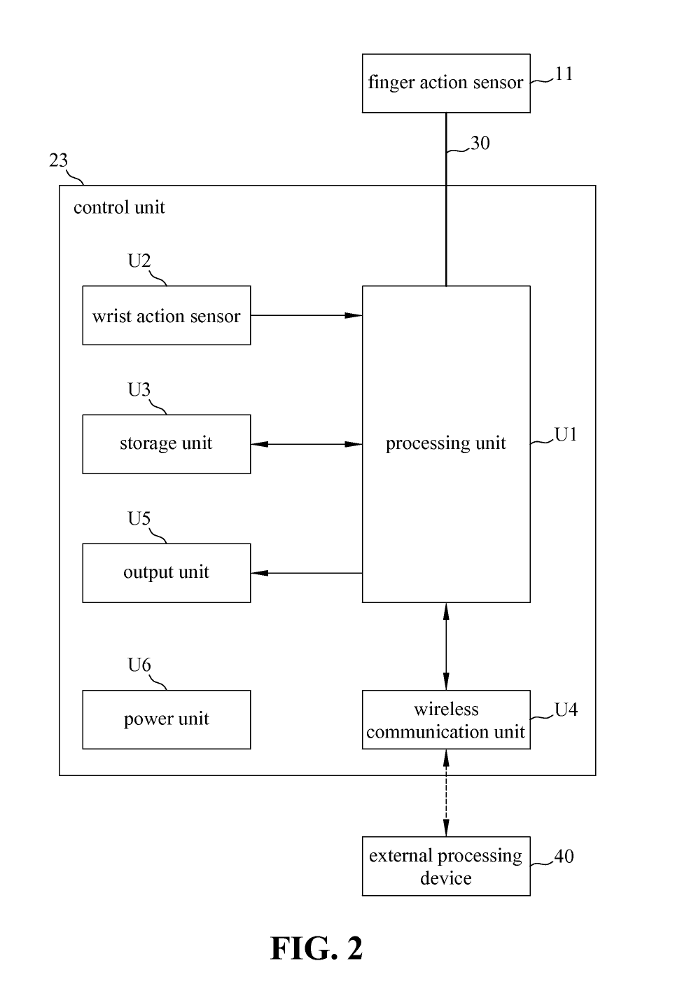

Additionally, the device body 20 on the wrist may comprise a support body 21 and a control unit 23. The support body 21 is a belt object designed for the wrist to insert, and the control unit 23 is integrated with the support body 21. To explain the technical characteristics of the present embodiment in more detail, please refer to FIG. 2. Specifically, the control unit 23 comprises a processing unit U1, a wrist action sensor U2, a storage unit U3, a wireless communication unit U4, an output unit U5 and a power unit U6. The power unit U6 comprises a primary cell or battery, a secondary or rechargeable cell or battery, or a solar cell to supply electricity, and the wrist action sensor U2, the storage unit U3, the wireless communication unit U4 and the output unit U5 are electrically connected to the processing unit U1 such that the processing unit U1 manipulates all the electrical operations.

More specifically, the processing unit U1 can be implemented by a MCU (microcontroller unit), and the wrist action sensor U2 comprises the accelerator, gyro or MEMS device with the function of sensing a three-axis displacement, acceleration and angular displacement. The storage unit U3 is configured to store a plurality of action models and operation parameters.

The wrist action sensor U2 senses the action of the wrist and generates the wrist action data, including the movement, acceleration and displacement of the wrist. The processing unit U1 receives the finger action data and the wrist action data, reads the action models and operation parameters from the storage unit U3 so as to calculate the integrated action data and the integrated action mode transmitted to the wireless communication unit U4, and generate the control signal transmitted to the output unit U5.

The wireless communication unit U4 is a WiFi or Bluetooth transceiver employing a wireless means to transmit the integrated action data and the integrated action mode to an external processing device 40, which is implemented by a television set, desktop PC (personal computer), laptop computer (notebook), tablet PC, mobile phone or display device with a wireless communication function for performing the corresponding operation based on the hand action information, such as moving the cursor on the PC or clicking an icon for a specific function.

Additionally, the wireless communication unit U4 may also receive the control information from the external processing device 40, including control instructions, control parameters and operation modes, which is stored in the storage unit U3 through the processing unit U1 and provided for the processing unit U1 to perform subsequent operations, thereby achieving the purpose of controlling the processing unit U1 by use of the external processing device 40.

It is preferred that the output unit U5 comprises a state display unit and/or an infrared (IR) transceiver unit (not shown). The state display unit is configured to display the information related to the control signal, such as action/still state, action type or state, current time, operation time, provided for the user to clearly understand the present operation situation. The IR transceiver unit transmits the IR ray to an external IR transceiver unit like an internet server, and also receives the information transmitted by the IR ray from the external IR transceiver unit. As a result, the function of bi-directional wireless connection, communication, transfer and control is achieved.

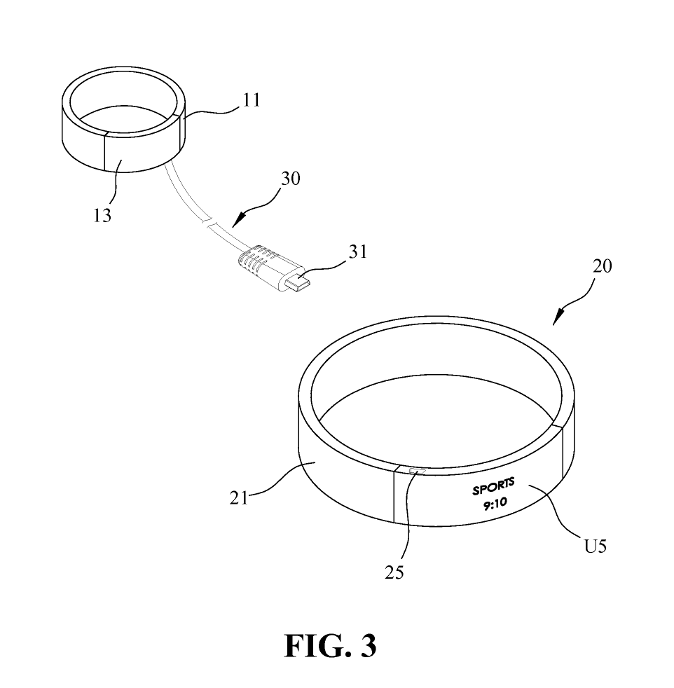

Refer to FIG. 3 for showing one illustrative example of the ring mobile device of the first embodiment. The device body 20 further comprises a connection hole 25, and the connection line 30 is fixed to the action ring 10 and has a connection plug 31. The connection plug 31 is configured to insert the connection hole 25. The output unit U5 is preferably a state display unit so as to directly show the related information to help the user understand the situation. The example in FIG. 3 shows that the connection line 30 is attachable from the connection hole 25 of the device body 20 such that the action ring 10 is separated from the device body 20, resulting in the flexibility and convenience in actual use.

It should be noted that the scope of the present invention is not intended to be limited by the above example illustrated in FIG. 3. In other words, all the elements or devices with the equivalent functions or features are also included by the present invention.

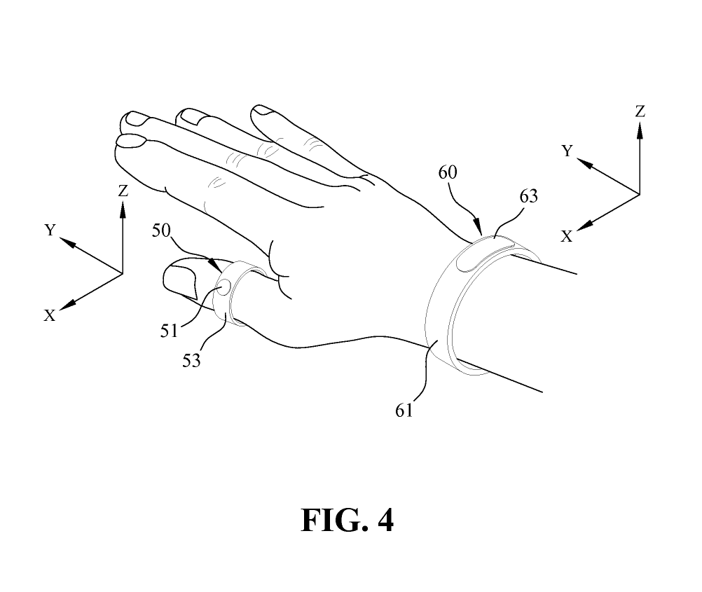

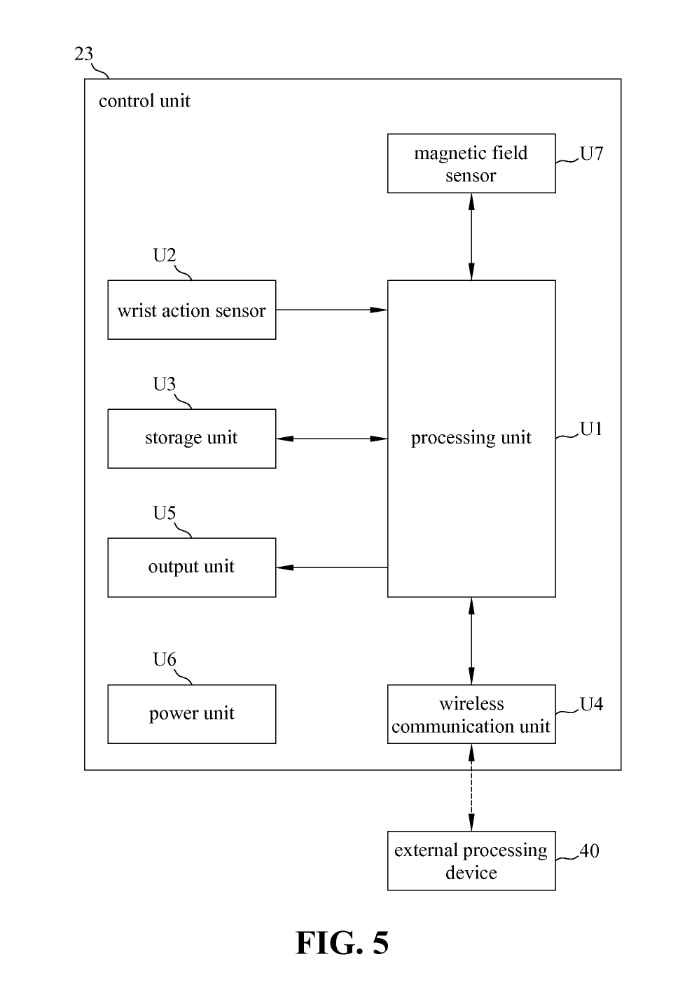

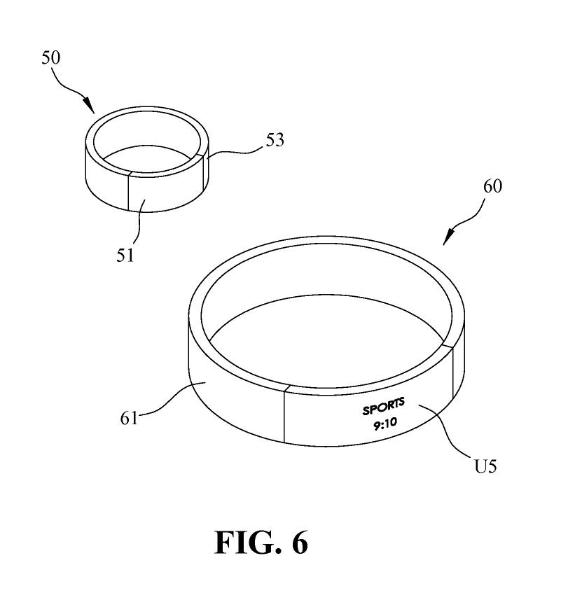

Further refer to FIGS. 4 and 5, illustrating the ring mobile device according to the second embodiment of the present invention and the functional blocks of the ring mobile device, respectively. Also, the illustrative example shown in FIG. 6 is provided for clear explanation. The ring mobile device of the second embodiment comprises an action ring 50 and a device body 60 configured to be worn on a finger and a wrist, respectively. The action ring 50 comprises a magnetic object 51 and a ring body 53, which are together. The device body 60 comprises a support body 61 and a control unit 63 integrated with the support body 61. Preferably, the magnetic object 51 is made of ferromagnetic material so as to generate the specific magnetic field.

As shown in FIG. 5, the control unit 63 comprises a processing unit U1, a wrist action sensor U2, a storage unit U3, a wireless communication unit U4, an output unit U5, a power unit U6 and a magnetic field sensor U7. The processing unit U1, the wrist action sensor U2, the storage unit U3, the wireless communication unit U4, the output unit U5 and the power unit U6 are similar to those mentioned in the first embodiment, and the detailed description is thus omitted hereinafter. Specifically, the magnetic field sensor U7 is a Hall element or an inductive element for sensing the intensity, position and direction of the magnetic field generated by the magnetic object 51 so as to form the finger action data, which is transmitted to the processing unit U1 for determining the finger action.

Therefore, one aspect of the finger action device according to the present invention is that the finger action sensor of the action ring is configured to sense the motion state of the tail part of the finger such as upward/downward/right/left swaying, rotating or spinning. The wrist action sensor of the control unit of the device body is used to sense the swaying and rotation vectors of the wrist. At the same time, the processing unit refers to the action models and operation parameters stored n the storage unit to obtain various integrated action data and action modes. Especially, the action ring is only worn on one finger without affecting other fingers for normal actions. The device body on the wrist is provided with a built-in power supply to provide electricity such that the device body is appropriate for being worn for a long period of time, thereby improving the convenience in use. Additionally, the control unit has the wireless communication unit such that the processing unit can transmit the integrated action data and the integrated action mode to the external processing unit or remote/backend device, which performs the more detailed analysis of the action and the corresponding control operation so as to increase the preciseness of determining the hand action. The present invention further employs the external processing or remote/backend device to wirelessly set the parameters and the operation mode of the ring mobile device. Thus, the purpose of programming and controlling is achieved, and the flexibility and variety of the application field are greatly enhanced.

The magnetic object of the action ring is configured to be worn on the finger and the processing unit senses the intensity, position and direction of the magnetic field generated by the magnetic object by a non-contact means such that the processing unit obtains the finger gesture the physical connection for the electrical signal and the power is omitted. As a result, the overall structure of the action ring is greatly simplified so as to improve the convenience and practicability.

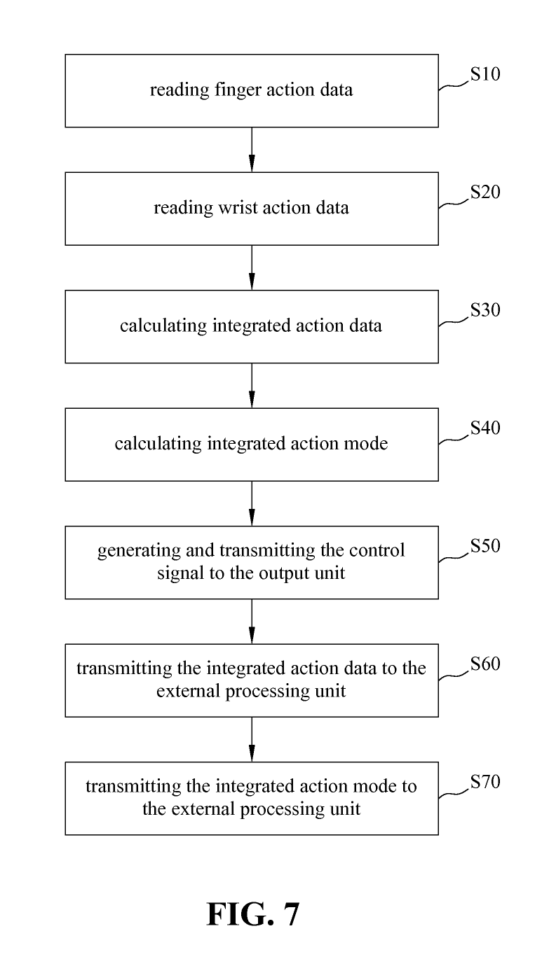

Furthermore, refer to FIG. 7 for showing the flowchart for the operation method of the ring mobile device according to the third embodiment of the present invention. The operation method of the present embodiment comprises the steps S10, S20, S30, S40, S50, S60 and S70, which are sequentially performed to sense the hand action by use of the ring mobile device comprising the action ring and the device body electrically connected by the connection line. The action ring and the device body are designed for being worn on the finger and the wrist, respectively. The action ring comprises the ring body and the finger action sensor, and the device body comprises the support body and the control unit. The control unit comprises the processing unit, the wrist action sensor, the storage unit, the wireless communication unit, the output unit and the power unit. The power unit supplies electricity, and the wrist action sensor, the storage unit, the wireless communication unit and the output unit are electrically connected to the processing unit. Please refer to FIGS. 1 and 2 for the electrical connection of the above components.

As shown in FIG. 7, the operation method of the present embodiment starts at step S10 by using the processing unit included in the device body to read the finger action data generated by the finger action sensor of the action ring through the connection line. Next, the step S20 is performed by reading the wrist action data generated by the wrist action sensor included in the deice body, and in the step S30, the finger action data and the wrist action data are analyzed to calculate and obtain the integrated action data.

Then, the step S40 is performed by comparing the integrated action data with a plurality of action models stored in the storage unit so as to calculate and obtain the integrated action mode. In the step S50, the control signal is generated based on the integrated action mode and further transmitted to the output unit, which is configured to display the related information such as number, text, symbol, icon, light, flash, vibration and sound, used to inform the operator of the current operation status including current operation mode, operation time, power capacity, and so on.

In the step S60, the wireless communication unit transmits the integrated action data to the external processing unit or the remote/backend device, and finally, the step S70 is performed by transmitting the integrated action mode to the external processing unit, which performs the corresponding predetermined backend operation based on the integrated action data and the integrated action mode. For instance, the backend operation for the external processing unit implemented by the desktop PC may comprise the step of moving the cursor on the PC, pulling down the menu or clicking the icon for some specific function based on the hand action information. In case of a robot hand as the external processing unit, the backend operation uses the hand action information to control the action of the robot hand such as flapping, flipping, holding, gripping, bending, turning, swaying, and so on.

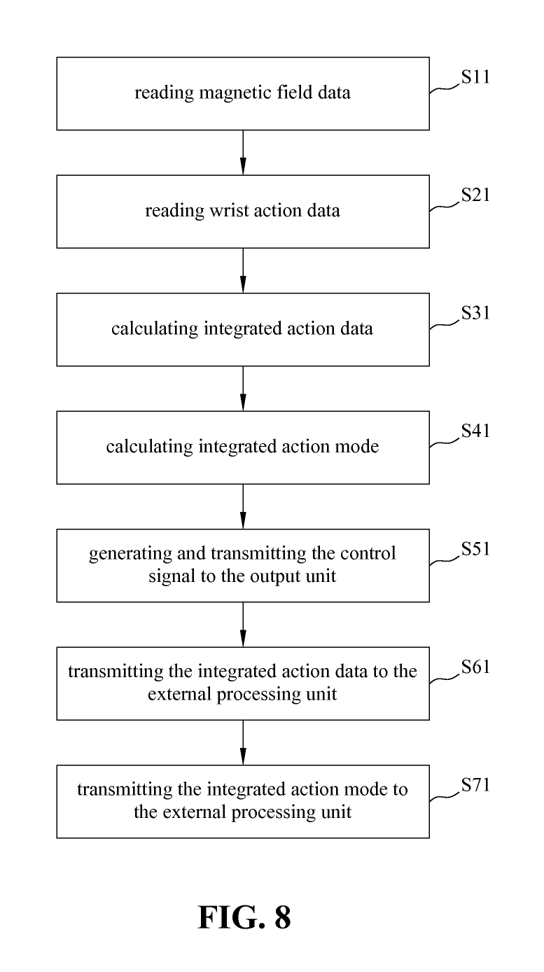

Additionally, the flowchart of the operation method of the ring mobile device according to the fourth embodiment of the present invention is shown in FIG. 8, comprising the steps S11, S21, S31, S41, S51, S61 and S71, which are sequentially performed. The technical characteristics of the operation method according to the fourth embodiment are similar to those of the above third embodiment, and the primary difference is that the method of the present embodiment employs the magnetic object to replace the finger action sensor in the third embodiment, the connection line is omitted and the control unit further comprises the magnetic field sensor such that the magnetic field generated by the magnetic object is sensed by the magnetic field sensor so as to generate the corresponding magnetic field data for the intensity, position and direction.

Specifically, the method of the present embodiment shown in FIG. 8 begins at the step S11 by reading the magnetic field data from the magnetic field sensor, and then the step S21 is performed by reading the wrist action data generated from the wrist action sensor. Then, in the step S31, the processing unit analyzes the finger action data and the wrist action data to calculate integrated action data.

Next, the step S41 is performed by comparing the integrated action data with the action models of the storage unit to find one action model matched with the integrated action data, as the integrated action mode. Enter the step S51. The processing unit generates the control signal based on the integrated action mode, and the control signal is transmitted to the output unit. The step S61 is then performed by transmitting the integrated action data to the external processing unit or the remote/backend device by use of the wireless communication unit. Finally, in the step S71, the wireless communication unit transmits the integrated action mode to the external processing unit or the remote/backend device for performing some preset backend operations.

From the above-mentioned, one aspect of the operation method is that the processing unit is used to receive the finger action data of the finger action sensor and the wrist action data of the wrist action sensor, and refer to the action models of the storage unit so as to calculate and obtain the integrated action data and mode, representing the actual action of the hand. The integrated action data and the integrated action mode are transmitted to the external processing unit through the wireless communication unit of the device body for further detailed analysis and corresponding control operations. The method also provides the wireless means for the external processing device to wirelessly set or update the operation modes and/or parameters of the finger action device.

Another aspect of the operation method is that the finger action sensor is replaced by the magnetic object and the magnetic field sensor is included in the device body to sense the magnetic field generated by the magnetic object and obtain the position/movement of the finger such that the action and gesture of the finger is calculated, thereby totally omitting the physical connection for the electrical signals and the power and greatly improving the stability and reliability of electrical operations. In particular, the technical characteristics of the present invention are not disclosed in any public journals, magazines or products, and the present invention thus possesses the novelty and technical progress. Therefore, the present invention overcomes the problems of the products in the prior arts, and provides practicability for the industries.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A ring mobile device, comprising:
an action ring for being worn on a finger, comprising a finger action sensor and a ring body, the finger action sensor configured to be integrated with the ring body, the finger action sensor sensing an action of the finger so as to generate finger action data;
a device body for being worn on a wrist, comprising a support body and a control unit, the control unit configured to be integrated with the support body; and
a connection line configured to connect the action ring and the device body,
wherein the control unit comprises a processing unit, a wrist action sensor, a storage unit, a wireless communication unit, an output unit and a power unit, the wrist action sensor, the storage unit, the wireless communication unit and the output unit are connected to the processing unit, the power unit provides electricity, the wrist action sensor is configured to sense an action of the wrist and generate wrist action data, the storage unit stores a plurality of action models and operation parameters, the processing unit receives the finger action data and the wrist action data, and reads the action models and operation parameters from the storage unit so as to calculate integrated action data and an integrated action mode which are transmitted to the wireless communication unit, and to generate a control signal transmitted to the output unit, and the wireless communication unit employs a wireless means to transmit the integrated action data and the integrated action mode to an external processing device performing a corresponding operation.

2. The ring mobile device as claimed in claim 1, wherein the finger action sensor comprises an accelerator, a gyro or a micro electronic mechanical system {MEMS} device with a function of sensing a three-axis displacement, acceleration and angular displacement, the power unit comprises a primary cell or battery, a secondary or rechargeable cell or battery, or a solar cell, the processing unit is implemented by a MCU (microcontroller unit), the wrist action sensor comprises an accelerator, a gyro or a MEMS device with a function of sensing a three-axis displacement, acceleration and angular displacement, the wireless communication unit is a WiFi or Bluetooth transceiver unit, and the output unit comprises a state display unit and/or an infrared transceiver unit.

3. A ring mobile device, comprising:
an action ring for being worn on a finger, comprising a magnetic object and a ring body, the magnetic object configured to be integrated with the ring body, the magnetic object generating a specific magnetic field; and
a device body for being worn on a wrist, comprising a support body and a control unit, the control unit configured to be integrated with the support body;
wherein the control unit comprises a processing unit, a magnetic field sensor, a wrist action sensor, a storage unit, a wireless communication unit, an output unit and a power unit, the magnetic field sensor, the wrist action sensor, the storage unit, the wireless communication unit and the output unit are connected to the processing unit, the power unit provides electricity,
the magnetic field sensor is configured to sense the electric field generated by the magnetic object to generate magnetic field data used to form corresponding finger action data, which is transmitted to the processing unit,
the wrist action sensor is configured to sense an action of the wrist and generate a corresponding wrist action data, the storage unit stores a plurality of action models and operation parameters, the processing unit receives the finger action data and the wrist action data, and reads the action models and operation parameters from the storage unit so as to calculate integrated action data and an integrated action mode which are transmitted to the wireless communication unit, and to generate a control signal transmitted to the output unit, and the wireless communication unit employs a wireless means to transmit the integrated action data and the integrated action mode to an external processing device performing a corresponding operation.

4. The ring mobile device as claimed in claim 3, wherein the magnetic object is formed of ferromagnetic material, the magnetic field sensor is a Hall element or an inductive element, the power unit comprises a primary cell or battery, a secondary or rechargeable cell or battery, or a solar cell, the processing unit is implemented by a MCU, the wrist action sensor comprises an accelerator, a gyro or a MEMS device with a function of sensing a three-axis displacement, acceleration and angular displacement, the wireless communication unit is a WiFi or Bluetooth transceiver unit, and the output unit comprises a state display unit and/or an infrared transceiver unit.

5. An operation method of a ring mobile device for sensing a hand action, the ring mobile device comprising an action ring for being worn on a finger, a device body for being worn on a wrist, the operation method comprising steps of:
using a processing unit included in the device body to read finger action data of action ring;
reading wrist action data generated by a wrist action sensor included in the deice body;
analyzing the finger action data and the wrist action data to calculate integrated action data;
comparing the integrated action data with a plurality of action models stored in a storage unit so as to calculate an integrated action mode;
generating and transmitting a control signal based on the integrated action mode to an output unit included in the device body so as to display related information and performing a corresponding operation;
using a wireless communication unit included in the device body to transmit the integrated action data to an external processing unit; and
transmitting the integrated action mode to the external processing unit for performing a corresponding operation.

6. The operation method as claimed in claim 5, wherein said finger action data is generated by a finger action sensor included in the action ring, each of the finger action sensor and the wrist action sensor is implemented by an accelerator, a gyro or a MEMS device with a function of sensing a three-axis displacement, acceleration and angular displacement, the power unit comprises a primary cell or battery, a secondary or rechargeable cell or battery, or a solar cell, the processing unit is implemented by a MCU (microcontroller unit), the wrist action sensor comprises an accelerator, a gyro or a micro electronic mechanical system {MEMS} device with a function of sensing a three-axis displacement, acceleration and angular displacement, the wireless communication unit is a WiFi or Bluetooth transceiver unit, and the output unit comprises a state display unit and/or an infrared transceiver unit.

7. The operation method as claimed in claim 5, wherein said finger action data is formed by using a magnetic field sensor included in the device body to sense a magnetic field generated by a magnetic object included in the action ring so as to generate magnetic field data used to form corresponding finger action data.

8. The operation method as claimed in claim 7, wherein the magnetic object is formed of ferromagnetic material, the magnetic field sensor is a Hall element or an inductive element, the wrist action sensor comprises an accelerator, a gyro or a MEMS device with a function of sensing a three-axis displacement, acceleration and angular displacement, the processing unit is implemented by a MCU, the wireless communication unit is a WiFi or Bluetooth transceiver unit, and the output unit comprises a state display unit and/or an infrared transceiver unit.
